(19) United States
(12) Patent Application Publication
(10) Pub. No.: US 2025/0280442 A1
(43) Pub. Date: Sep. 4, 2025

(54) IMPROVED r-TWT-BASED COMMUNICATION METHODS FOR P2P STREAM

(71) Applicant: CANON KABUSHIKI KAISHA, Tokyo (JP)

(72) Inventors: Pascal VIGER, JANZE (FR); Romain GUIGNARD, RENNES (FR)

(21) Appl. No.: 18/858,687

(22) PCT Filed: Apr. 19, 2023
(86) PCT No.: PCT/EP2023/060108

§ 371 Date: Oct. 21, 2024

(30) Foreign Application Priority Data
Apr. 22, 2022 (GB) 2205904.2
Mar. 10, 2023 (GB) 2303580.1

(51) Int. Cl. H04W 74/0816; H04W 52/02; H04W 74/04

(52) U.S. Cl. CPC H04W 74/0816; H04W 52/0235; H04W 74/04

(57) ABSTRACT

To perform P2P transmissions within restricted Target Wake Time service period, rTWT service periods, an initiator peer station establishes membership in an rTWT schedule with the AP of the BSS, establishes a Tunneled Direct Link Setup, TDLS, session with its partner peer station, and efficiently notifies the partner peer station about the rTWT schedule using a TDLS Action frame that carries rTWT information, such as a Broadcast TWT Identifier, about the rTWT schedule. The TDLS Action frame may be a modified TDLS Peer Traffic Indication frame or of a new type or the modified TDLS Setup Request Action frame used for the TDLS session establishment. Thanks to this notification, the partner peer station can awake at the appropriate times of the rTWT service periods as specified in beacon frames from the AP, in order to receive or exchange peer-to-peer data directly with the initiator peer station.

### FIELD OF THE INVENTION

The present invention generally relates to wireless communications and more specifically to Peer-to-Peer (P2P) communication.

### BACKGROUND OF INVENTION

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

Low latency reliable services, LLRS, have been defined as targets of such main objective. LLRSs are services provided to a higher layer traffic stream that prioritize and deliver MSDUs (data units) within a worst-case latency budget with a given reliability/packet delivery ratio (PDR) and low jitter.

The IEEE P802.11be/D1.5 version (March 2022, below the “D1.5 standard”) introduces the Multi-link (ML) operation (MLO). MLO improves data throughput by allowing communications between stations over multiple concurrent and non-contiguous communication links.

Multi-Link Operation enables a non-AP (access point) MLD (ML device) to register with an AP MLD, i.e. to discover, authenticate, associate and set up multiple links with the AP MLD. Each link enables channel access and frame exchanges between the non-AP MLD and the AP MLD based on supported capabilities exchanged during association.

A MLD is a logical entity that has more than one affiliated station (AP or non-AP) and has a single medium access control (MAC) service access point (SAP) to logical link control (LLC), which includes one MAC data service. An AP MLD is thus made of multiple affiliated APs whereas a non-AP MLD is made of multiple affiliated non-AP stations. The affiliated stations in both AP MLD and non-AP-MLD can use 802.11 mechanisms to communicate with affiliated stations of another MLD over each of the multiple communication links that are set up.

To meet low latency requirements in EHT as well as to increase efficiency of the UL MU operation, existing mechanisms have been reused within the D1.5 standard and improved, while other new mechanisms have been added.

The Stream Classification Service (SCS) mechanism, originally defined in the IEEE 802.11aa standard, has been adapted to be included in the D1.5 standard. The SCS mechanism for multi-link now allows a non-AP MLD to define and advertise the AP MLD of a (latency sensitive) traffic stream identified with an SCS identifier, SCSID. An adaptation of the SCS mechanism allows QoS requirements to be defined for the SCS stream through so-called QoS Characteristics element, in particular to classify the SCS stream as belonging to a TID class for a corresponding uplink (UL) or downlink (DL) direction.

The Target Wake Time (TWT) mechanism, originally defined in the IEEE 802.11ah and 802.11ax standards, has been adapted to be included in the D1.5 standard. An adaptation is known as the Restricted Target Wake Time (rTWT) which schedules dedicated (and protected) service periods (SPs) for stations to convey their latency sensitive traffic(s), e.g. SCS streams, over the BSS. An rTWT agreement is nothing more than a Broadcast TWT agreement negotiated between an AP and an associated non-AP station of the BSS. The non-AP station establishes with the AP membership in a Broadcast TWT (or rTWT) schedule. The schedule may be defined for some TIDs (i.e. QoS characteristics as specified through the SCS mechanism). The rTWT Service Periods SPs of the rTWT schedule, in which SPs the protected exchanges of SCS traffic streams may take place, are advertised in broadcast management frames (e.g. beacons), using an rTWT information about the negotiated rTWT SPs, typically a Broadcast TWT ID (bTWT ID).

The Triggered TXOP Sharing (TXS) mechanism allows an AP to allocate a portion of the time within an obtained TXOP to only one associated non-AP 802.11be station for the latter to transmit one or more non-TB PPDUs. This looks like single-user (SU) triggering. A specific trigger frame is used to that end which is called MU-RTS TXS and specifies the time duration allocated to the non-AP station within the TXOP obtained by the AP. The TXS mechanism facilitates P2P (peer-to-peer or Direct Link—DiL) communications within a TXOP obtained by the AP.

These various mechanisms operate together with difficulties, in particular with respect to latency sensitive P2P traffics.

On one hand, the AP-centric aspect of the 802.11 MU transmission scheme involved in the SCS and rTWT mechanisms is not adapted to bandwidth-demanding communication services (e.g. video-based services such as gaming, virtual reality, streaming applications) because all the communications go through the AP, thereby doubling the air time for transmission but also the number of medium accesses (and thus of medium access time).

On the other hand, as the SCS and rTWT mechanisms are negotiated between an initiator non-AP station and the AP, hence excluding the other peer non-AP station partner to the P2P (or DiL) communication with the initiator peer non-AP station, there are few chances that the partner peer non-AP station be awake and therefore available for TXS-based P2P communication within an rTWT SP of the negotiated rTWT schedule.

In other words, the D1.5 standard is for the moment not satisfactory with respect to P2P or DiL transmissions. Transmissions as conventionally specified through rTWT can be improved.

### SUMMARY OF THE INVENTION

It is a broad objective of the present invention to overcome some of the foregoing concerns.

The inventors have sought to improve this situation by taking benefit of the promising rTWT mechanism to facilitate the P2P communications. In this context, they have searched for mechanisms to correctly (given the standardized mechanisms) notify the partner peer non-AP station of the BSS about the rTWT schedule negotiated between the initiator peer non-AP station and the AP of the BSS, in order for the partner peer to be awake for the next rTWT SP of the rTWT schedule, hence to be available for P2P communication should the initiator peer be allocated a portion of time during that service period.

In this context, there is provided a peer-to-peer communication method in a wireless network, comprising at an initiator peer non-access point, AP, station of a BSS:
establishing a restricted Target Wake Time, rTWT, schedule with an AP of the BSS,
notifying a partner peer non-AP station of the BSS about the rTWT schedule, wherein notifying includes sending, to the partner peer non-AP station, a TDLS Action frame including rTWT information about the rTWT schedule, and
exchanging, during one or more rTWT service periods, SPs, of the rTWT schedule, peer-to-peer data directly (i.e. without forwarding by the AP) with the partner peer non-AP station.

From the partner perspective, there is provided a peer-to-peer communication method in a wireless network, comprising at a partner peer non-access point, AP, station of a BSS managed by an AP:
receiving a notification from an initiator peer non-AP station of the BSS about a restricted

Target Wake Time, rTWT, schedule in which the initiator peer non-AP station has established membership with the AP of the BSS, wherein the notification includes a TDLS Action frame including rTWT information about the rTWT schedule, and
exchanging, during one or more rTWT service periods, SPs, of the rTWT schedule, peer-to-peer data directly with the initiator peer non-AP station.

Tunneled Direct Link Setup (TDLS) allows two non-AP stations to set up a P2P session by exchanging signaling frames through the AP, but in a transparent fashion for the AP (because they are conveyed in Data frames). Using the TDLS Action frames to notify another TDLS peer with the rTWT schedule negotiated with the AP for P2P transmission is of high benefit because it is still transparent for the AP while relying on existing frames. Hence it can be included in exchanged frames without requiring additional frames to be sent. Furthermore, the TDLS mechanism advantageously operates within the BSS managed by the AP, as the SCS and rTWT mechanisms also do. Therefore, a TDLS initiator station sends to its TDLS responder station a TDLS Action frame including an rTWT information about the rTWT schedule.

Optional features of the invention are defined below with reference to a method, while they can be transposed into device features.

In some embodiments, the rTWT information includes a Broadcast TWT identifier, bTWT ID, identifying the rTWT schedule.

For example, the rTWT information is made of the bTWT ID only. This approach reduces overhead while providing simplicity to signal the rTWT SPs.

In another example, the rTWT information includes or is made of a Broadcast TWT Info subfield including the bTWT ID. This approach advantageously signals the partner peer about the time window (lifetime) within which the rTWT SPs of the schedule are provided. Indeed, the D1.5 standard provides that the Broadcast TWT Info subfield includes the Broadcast TWT Persistence indication to that end.

In yet another example, the rTWT information includes or is made of a Restricted TWT Parameter Set subfield including the bTWT ID. The partner peer is then provided with complete information about the rTWT SPs.

Beside, in a particular embodiment, the Restricted TWT Parameter Set subfield includes a Restricted TWT P2P TID Bitmap subfield specifying which Traffic Identifier, TID, or TIDs are allowed as latency sensitive traffic streams for peer-to-peer exchange within the rTWT schedule. This subfield can be additional to (already standardized) UL and DL TID Bitmap subfields specifying which TID(s) are identified as latency sensitive traffic streams in the uplink and downlink directions, respectively. This indication helps the AP to keep control on the P2P traffic that is allowed to be exchanged during the service periods of the rTWT schedule, while informing the partner peer of such limitation.

In a more particular embodiment, the TDLS Action frame includes both the Restricted TWT Parameter Set subfield and a TPU Buffer Status field containing information regarding traffic buffered at the initiator peer non-AP station at the time the TDLS Action frame is sent, wherein only buffered traffic corresponding to the TID or TIDs specified in the Restricted TWT P2P TID Bitmap subfield is reported in the TPU Buffer status field. Better fairness of the buffer reports is therefore achieved.

In some embodiments, the TDLS Action frame includes an Action frame of the TDLS category (meaning TLDS Action frame) with a TDLS Action field of TDLS Peer Traffic Indication or TDLS Peer Power Save Mode Request and/or Response. This advantageously relies on an existing format (TDLS Action field is 4 or 8), hence avoiding defining a new type of TDLS Action frame.

In other embodiments, the TDLS Action frame includes an Action frame of the TDLS category with a TDLS Action field set to any value from 11 to 255 to define a TDLS Peer rTWT

Indication. These values are reserved in the D1.5 standard. They allow a new type of TDLS Action frame to be defined for rTWT signaling in a P2P (TDLS) session.

In yet other embodiments, the TDLS Action frame includes a TDLS Setup Request Action frame (TDLS Action subfield is 0) to establish a Tunneled Direct Link Setup, TDLS, session between the two peer non-AP stations. These embodiments advantageously signal the rTWT schedule during the setup of a TDLS session, hence avoiding overhead due to additional frames.

In particular embodiments, the method further comprises exchanging a TDLS Setup Response Action frame and a TDLS Setup Confirm Action frame between the two peer non-AP stations (the frames usually complete the TDLS session setup), wherein the TDLS Setup Response and Confirm Action frames include the rTWT information. The rTWT information is therefore repeated during the multiple frames to set up the TDLS session to fully confirm and thus validate the rTWT scenario between the peers.

In some embodiments, the method further comprises, at the initiator peer non-AP station, prior to establishing membership in the rTWT schedule, negotiating a Tunneled Direct Link Setup, TDLS, session with the partner peer non-AP station, wherein the TDLS Action frame is sent within the TDLS session.

From the partner perspective, the method further comprises, at the partner peer non-AP station, negotiating a Tunneled Direct Link Setup, TDLS, session with the initiator peer non-AP station, wherein the TDLS Action frame is received within the TDLS session once established (after it has been set up).

This scenario allows the rTWT to be negotiated for P2P communication even if the P2P (TDLS) session is established. This provides more flexibility in the management of the network.

In some embodiments, the initiator peer non-AP station or the partner peer non-AP station (usually both) is affiliated to a non-AP multi-link device, MLD. The above management of P2P communications can therefore be implemented at each or multiple links of the non-AP MLDs.

Correlatively, the invention also provides a wireless communication device comprising at least one microprocessor configured for carrying out the steps of any of the above methods. The wireless communication device may be either of a non-AP MLD and an AP MLD.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical wireless communication system in which embodiments of the invention may be implemented;

FIG. 2 illustrates, using frame exchanges in a timeline, a possible scenario for an initiator peer non-AP STA to handle P2P traffic;

FIG. 3 illustrates the data payload, in the format of a Tunneled Direct Link Setup, TDLS, Action frame, of a Data frame;

FIG. 4 illustrates a Stream Classification Service, SCS, descriptor included in SCS frames;

FIG. 5 illustrates a format of a Target Wake Time, TWT, element adapted to be used for r-TWT according to the D1.5 standard.

FIG. 6 illustrates, using flowcharts, exemplary steps at the peer non-AP MLDs (or stations) according to some embodiments of the invention.

FIG. 7 illustrates a modified Restricted TWT Traffic Info subfield within a Restricted TWT element, according to embodiments of the invention.

FIG. 8 illustrates, using frame exchanges in a timeline, the scenario of FIG. 2 when the initiator peer notifies its partner peer of an rTWT schedule for P2P low latency traffic streams according to embodiments of the invention.

FIG. 9 illustrates, using flowcharts, exemplary steps at the peer non-AP MLDs (or stations) according to alternative embodiments to FIG. 6.

FIG. 10 illustrates, using frame exchanges in a timeline, an alternative scenario to FIG. 8, wherein the establishment of membership in an rTWT schedule is made was prior to the establishment of the P2P session.

FIG. 11a shows a schematic representation a communication device according to at least one embodiment of the present invention;

FIG. 11b illustrates schematically the architecture of the communication device of FIG. 11a; and

FIGS. 12a, 12b, 12c, 12d, 12e and 12f illustrate exemplary modifications for tables containing information for TDLS Setup Request Action field, TDLS Setup Response Action field, TDLS Setup Confirm Action field, TDLS Peer Traffic Indication Action field, TDLS Peer PSM Request Action field and TDLS Peer PSM Response Action field, respectively.

### DETAILED DESCRIPTION OF THE INVENTION

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to transmit simultaneously data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

While the examples are described in the context of WiFi® networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base STA (gNB), Base STA Controller (“BSC”), Base Transceiver STA (“BTS”), Base STA (“BS”), Transceiver Function (“TF”), Radio Router, Radio Transceiver, Basic Service Set (“BSS”), Extended Service Set (“ESS”), Radio Base STA (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification, BSSID and managed by a separate virtual AP implemented in the physical AP.

The 802.11 family of standards define various media access control (MAC) mechanisms to drive access to the wireless medium.

The current discussions in the task group 802.11be, as illustrated by draft IEEE P802.11be/D1.5 of March 2022, introduce the Multi-Link Operation (MLO) when it comes to MAC layer operation. The MLO allows multi-link devices to establish or setup multiple links and operate them simultaneously.

A multi-link device (MLD) is a logical entity and has more than one affiliated (AP or non-AP) station (STA) and has a single medium access control (MAC) service access point (SAP) to logical link control (LLC), which includes one MAC data service. Besides, the MLD also comprises a single address associated with the interface, which can be used to communicate on the distribution system medium (DSM).

The stations forming the same MLD may be partly or all collocated within the same device or geographically dispersed.

An access point multi-link device (AP MLD) corresponds to a MLD where each station (STA) affiliated with the MLD is an AP, referred to as “affiliated AP” hereinafter.

A non-access point multi-link device (non-AP MLD) corresponds to a MLD where each station (STA) affiliated with the MLD is a non-AP station, referred to as “affiliated non-AP station”.

When referring hereinafter to either an AP MLD or a non-AP MLD, the general term “station MLD” may be used.

Depending on the literature, “multilink device”, “ML device” (MLD), “multilink logical entity”, “ML logical entity” (MLE), “multilink set” and “ML set” are synonyms to designate the same type of ML device.

Multiple affiliated non-AP STAs of a non-AP MLD can then setup communication links with multiple affiliated APs of an AP MLD, hence forming a multi-link channel. This is for instance done through the conventional association procedure: ML Discovery including passive scanning (ML beacons) or active scanning (ML Probe Request and corresponding Response), following by ML Authentication and finally by ML Setup where the non-AP MLD associates with the AP MLD (hence obtained an Association IDentifier, AID) and sets up the ML links for its affiliated non-AP STAs with the APs affiliated with the AP MLD.

The links established (or “enabled links”) for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHz, 40 MHz, and so on) in a given frequency band (e.g. 2.4 GHz, 5 GHz, 6 GHz) between an AP affiliated with the AP MLD and a non-AP STA affiliated with the non-AP MLD.

The affiliated APs and non-AP STAs operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

The terms “traffic” and/or “traffic stream(s)” as used herein, are defined as a data flow and/or stream between wireless devices.

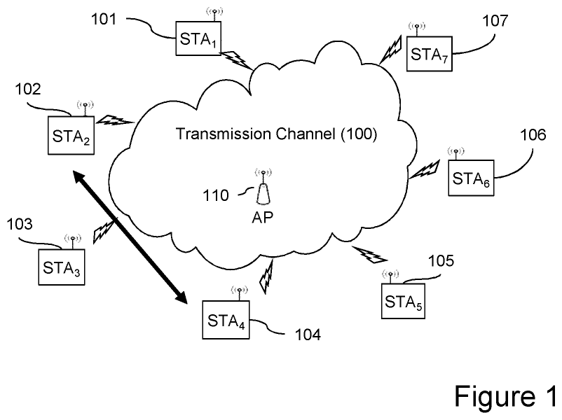

FIG. 1 illustrates a wireless communication system in which several communication station devices 101-107, 110 exchange data frames over a radio transmission channel 100 of a wireless local area network (WLAN), under the management of a central station, namely access point device (AP) 110. Direct communications between STAs can also be implemented without the use of an access point (known as an Ad-hoc mode). The radio transmission channel 100 is defined by an operating frequency band constituted by a single channel, a plurality of channels forming a composite channel, or a plurality of distinct channels (links) forming a multi-link operation.

In the following description, the term “station” or “STA” may be used to describe a non-AP station operating on a given link of 100, which may be a standalone non-AP station or an affiliated non-AP station entity of a non-AP MLD device. Similarly, the term “AP” describes an AP station operating on a given link, which may be a standalone AP station or an affiliated AP station entity of an AP MLD device.

Exemplary situations of direct communications, corresponding to an increasing trend nowadays, include the presence of peer-to-peer (P2P, also known as Direct Link or “DiL”) transmissions in between non-AP stations, e.g. STA 102 and STA 104 as illustrated in the Figure. Technologies that support P2P transmissions are for example WiFi-Miracast® or Wireless Display scenario, or Tunneled Direct Link Setup (TDLS). Note that even if P2P flows are usually not numerous, the amount of data per flow may be huge (typically low-compressed video, from 1080p60 up to 8K UHD resolutions).

Each STA 101-107 registers to the AP 110 during an association procedure. During the association procedure, the AP 110 assigns a specific Association IDentifier (AID) to the requesting STA. For example, the AID is a 16-bit value uniquely identifying the STA. When the AP and non-AP STA are respectively an affiliated AP of an ML AP device and an affiliated non-AP of a ML non-AP device, they establishing a ML association wherein an unique AID is assigned to the entire non-AP MLD: all affiliated non-AP STAs are identified by same AID value on their respective operation link.

The stations 101-107, 110 may compete on a given link one against the other using EDCA (Enhanced Distributed Channel Access) contention, to access the wireless medium in order to be granted a transmission opportunity (TXOP) and then transmit (single-user, SU) data frames. The stations may also use a multi-user (MU) scheme in which a single station, usually the AP 110, is allowed to schedule a MU transmission, i.e. multiple simultaneous transmissions to or from other stations, in the wireless network. One implementation of such a MU scheme has been for example adopted in IEEE Std 802.11ax-2021 standard, as the Multi-User Uplink and Downlink OFDMA (MU UL and DL OFDMA) procedures.

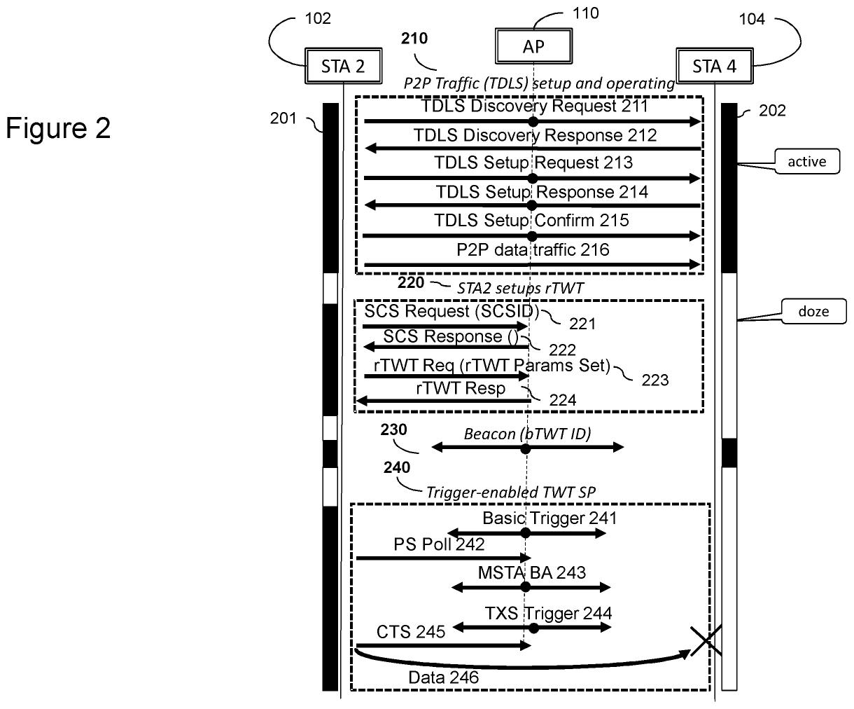

FIG. 2 illustrates, using frame exchanges in a timeline, a possible scenario for an initiator peer non-AP STA to handle P2P traffic.

This example involves STA 2 102 as the initiator for the P2P communication and STA 4 104 as the partner for the P2P communication. They both take part of the same BSS on a given link, and are associated with AP 110. As mentioned above, STA 2 and STA 4 may be non-AP stations affiliated to respective non-AP MLDs, while AP 110 may be an AP affiliated to an AP MLD.

In the Figure, the vertical state bands 201 and 202 show the states of STA 2 and STA 4 over time, respectively, hence their activity. The black portions of the bands represent the active (or awake) state of the corresponding station, while the white portions represent the doze (sleep) state. Conventional mechanisms are known to switch from one state to the other. For example, a station in the doze state usually wakes up (switched to the active state) at beacon times to receive the beacon frames.

In the sequence, once STA 2 and STA 4 are associated with the AP (association not shown), they can exchange data over their operation link (phase 210).

For example, a P2P session can be opened (WiFi-Miracast, TDLS, etc.) during phase 210.

As a legacy P2P mechanism remaining considered in 802.11, Tunneled direct-link setup (TDLS) is characterized by the use of signaling frames that are encapsulated in Data frames so that the signaling frames are transmitted through the AP transparently. Therefore, the AP does not need to be direct-link aware, nor does it have to support the same set of capabilities that are used on the direct link, in order for TDLS to be used.

In the sequence shown, a TDLS session or “TDLS direct link” is established between STA 2 and STA 4 (either of both can be the initiator of the establishment). The establishment may include a TDLS discovery (option) and a TDLS setup. At that time, both STA 2 and STA 4 are in the active state.

TDLS discovery and setup between STA 2 and STA 4 involve frames that are usually sent and received via intermediate AP 110. The TDLS procedure is characterized by encapsulating signalling frames in 802.11 Data frames, which allows them to be transmitted through the AP transparently.

When attempting to discover TDLS stations in the same BSS, a series of frame exchanges is used. STA 2, which is the initiator in the proposed scenario, sends a TDLS Discovery Request frame 211, tunneled through AP 110, to an individual destination station, here STA 4. This request frame conveys a Link Identifier element including a BBSID field, a TDLS initiator STA address field and a TDLS responder STA address field. The BSSID field is set to the BSSID of the BSS of which initiator STA 2 is a member. The TDLS initiator STA Address field is set to the TDLS initiator STA's MAC address, hence the one of STA 2. The TDLS responder STA Address field is set to the TDLS responder STA's MAC address, hence the one of STA 4. Destination station STA 4 responds with a TDLS Discovery Response frame 212 directly to STA 4 (without relay by AP 110).

When attempting to establish a TDLS direct link over a single link with the discovered TDLS station, a series of frame exchanges is used to set up a TDLS link. Initiator STA 2 (TDLS initiator) first sends a TDLS Setup Request frame 213, tunneled through AP 110 (relay illustrated by the black dot), to target partner STA 4 (TDLS responder). This frame includes information about the capabilities of initiator STA 2 and an AID thereof. Target partner STA 4 responds with a TDLS Setup Response frame 214, also tunneled through AP 110, including information about its capabilities, its AID plus a status code that either accepts or rejects the setup request. If the Setup Request is accepted, initiator STA 2 then sends a confirmation, TDLS Setup Confirm frame 215, via AP 110. This concludes the TDLS setup handshake. At this point, the two stations know the identity of the other on the one hand with the MAC address and on the other hand with the AID.

The stations can then start to communicate directly: P2P traffic 216 can then be directly (not black dot shown at the AP in the Figure for arrow 216) exchanged between STA 2 and STA 4 using the established TDLS session. A TDLS peer is then configured to accept Data frames received directly from the other peer. The frame exchanges are performed over the same link, that is to say the same frequency channel so that this P2P traffic becomes concurrent to other traffic for AP.

The discovery procedure may also rely on scan procedure on predefined band with a listen and a search state as described for WiFi-Miracast®. This discovery procedure also makes it possible to get the identities of the peer STAs.

Details on the TDLS procedure are provided in IEEE 802.11z, and have been upgraded to be established over one link among possibly multiple links as provided in the D1.5 standard.

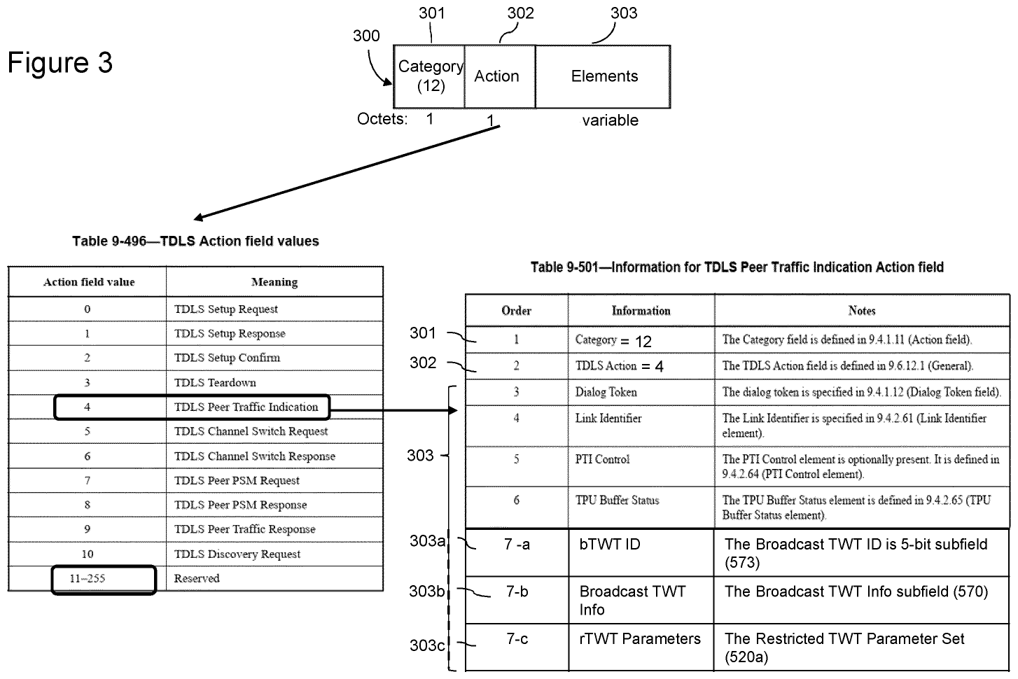

With reference to FIG. 3, the data payload of a TDLS frame is shown under reference 300.

Data payload 300 has the format of a frame, hence having a Category field 301, an Action field 302 immediately after the Category field 301 and an Elements field 303.

Various values of the Category field 301 are defined in the 802.11 standard, corresponding to various Actions frames. Category field set to 12 defines a TDLS Action frame, while Category field set to 4 defines a Public Action frame.

### TDLS Action Frames Conveys TDLS Signalling

1-byte Action field 302 for a TDLS Action frame may take various values from 0 to 10 (11 to 255 being reserved), as shown in Table 9-496 of the 802.11 Standard (as example, IEEE P802.11-REVme™/D1.0, December 2021 provides the latest allocation for those standardized values), corresponding to various signalling. For example, TDLS Setup Request frame 213 can be identified by Action field 302 set to 0; TDLS Setup Response frame 214 by Action field 302 set to 1; and TDLS Setup Confirm frame 215 by Action field 302 set to 2.

For illustrative purposes, Table 9-501 of the 802.11 Standard reproduced in FIG. 3 shows the elements 303 to be provided for TDLS Peer Traffic Indication frame (Action field 302 set to 4). Each type of TDLS Action frame has its own set of elements 303 to be provided (defined in the standard).

Similarly, 1-byte Action field 302 for a Public Action frame may take various values from 0 to 45 (46 to 255 being reserved). For example, TDLS Discovery Response frame 211 can be identified by Action field 302 set to 14.

Back to FIG. 2, initiator STA 2 may wish to take benefit of enhanced services provided by AP 110 that are related to low latency traffics from real time applications that have stringent latency requirements. These include the Stream Classification Service (SCS) mechanism and the Restricted Target Wake Time (rTWT) mechanism.

To meet low latency requirements in EHT as well as to increase efficiency of the MU UL operation, the Stream Classification Service (SCS) mechanism, originally defined in the IEEE/802.11aa standard, has been proposed to be used as a light-weight mechanism for a non-AP station to inform the AP of its QoS requirements, especially for low-latency traffics.

Low latency reliable services, LLRS, are services provided to a higher layer traffic stream that prioritize and deliver MSDUs within a worst-case latency budget with a given reliability/packet delivery ratio (PDR) and low jitter. Traffic that may be concerned by LLRS includes latency sensitive data, i.e. data from applications such as gaming, media streaming, augmented reality, virtual reality, and so on.

Originally, the SCS mechanism allowed the establishment of traffic streams with higher layer signalling of packet drop eligibility (e.g. allowed some packets in the traffic stream to be tagged as drop eligible) and allowed classification of traffic streams into an access category, using TCLAS—Traffic CLASsification—processing.

The typical scenario of using SCS consisted in working with local traffic streams, wherein subsequently the SCS mechanism provides signalling for selecting some packets (drop-eligible ones) in the traffic streams with a view of discarding them in case of insufficient channel capacity. In short, the SCS mechanism aims to differentiate between separate traffic streams within the same access category or the same TID, and covers the need to allow for the graceful degradation of the traffic stream in case of bandwidth shortage.

The SCS mechanism has been adapted to the ML context. As shown in the D1.5 standard, a Multi-Link SCS procedure is now provided in the context of robust audio-video streaming.

Like in IEEE 802.11aa, the Multi-Link SCS procedure provides SCS Request frames, either to create/add, modify, or delete a SCS stream, and corresponding SCS Response frames. A SCS stream is defined in those SCS Request frames through a so-called SCS descriptor, and is identified by a SCS identifier, SCSID, in the SCS Response frames.

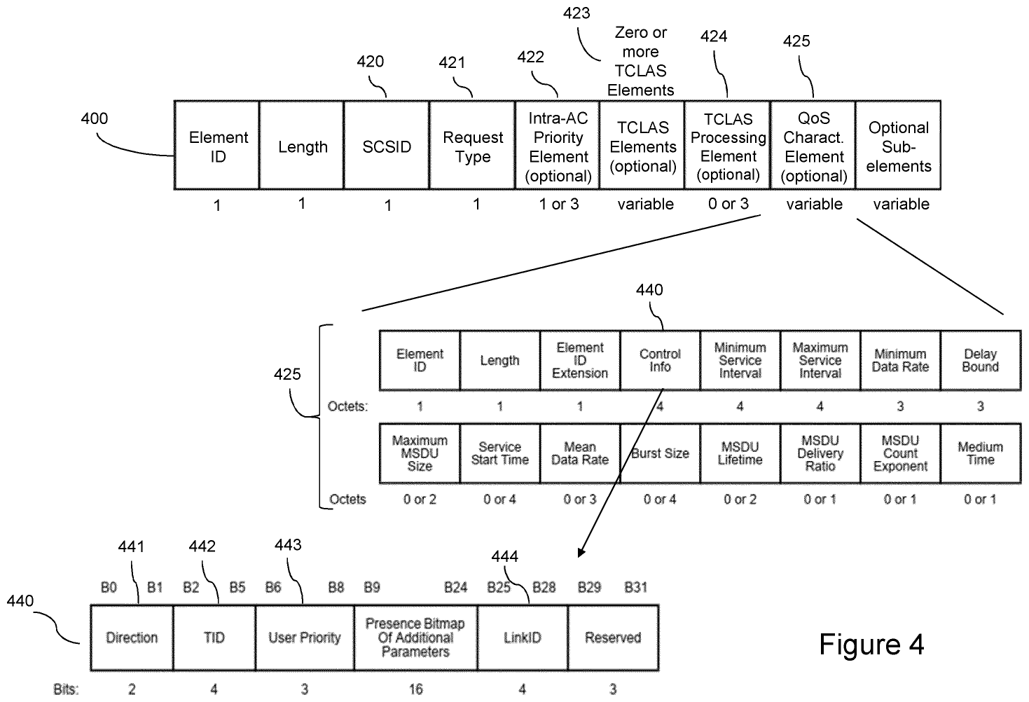

FIG. 4 illustrates the SCS descriptor included in those SCS frames. It includes:
SCSID field 420. Each traffic stream is assigned an ID by an affiliated non-AP station requesting classification. This ID, named SCSID 420, is unique across the non-AP MLD, because it is managed at MLD level;
Request Type field 421 takes a value to identify the type of SCS request: Add, Remove, or Change;
Optional Intra-Access Category Priority element 422 provides information to the AP MLD on the relative priorities of the SCS traffic streams within an AC. It corresponds to the optional introduction of two alternate queues proposed by the IEEE 802.11aa standard, compared to the four primary queues of EDCA;
TCLAS Elements 423 and TCLAS Processing Element 424, if present, describe the criteria for traffic classification the non-AP MLD requests the AP MLD to apply to identify the data or MSDUs forming the corresponding SCS stream. These elements are mandatory for downlink direction (traffic from the AP MLD to the non-AP MLD), but are forbidden in the current standard for other directions (UL or for direct link); and
a Traffic Specification, called QoS Characteristics Element 425. QoS Characteristics Element field 425 contains zero or one QoS Characteristics element to describe the traffic characteristics and QoS expectations of traffic flows that belong to this SCS traffic stream.

The QoS Characteristics are taken into account by the AP MLD or AP to properly schedule the non-AP MLD or non-AP station to transmit the local SCS stream. As an example, the AP MLD may enable the transmission of frames from the non-AP MLD with an interval that falls between the requested minimum and maximum service intervals and the AP MLD may meet the minimum data rate requested if the Direction subfield of the QoS Characteristics element indicates uplink or direct-link.

As shown in the Figure, various fields are provided in QoS Characteristics element 425 that define various QoS transmission parameters for the local SCS stream.

Control Info field 440 within QoS Characteristics element 425 is defined as follows:
Direction subfield 441 specifies the direction of data forming the stream: Uplink (field set to 0), Downlink (1) or Direct-link (2).
TID subfield 442 contains the target TID value of the MSDUs belonging to the local SCS stream (i.e. as described by the SCS Descriptor 400). In practice, this TID can then be used by the AP MLD or AP to schedule (e.g. polling Buffer status reports, allocating resources in emitted trigger frames) the SCS stream, rather than using the SCSID.
User Priority subfield 443 contains the UP (value 0-7) of the data frames that are described by this element. When the TCLAS element 424 is present in the SCS frame containing this element, the User Priority subfield is set to the user priority value specified in the TCLAS element,
LinkID subfield 444 contains the link identifier of the link for which the P2P or direct link transmissions are going to occur (therefore only considered when Direction subfield 441 specifies Direct-link).

Other subfields of QoS Characteristics element 425 are of less importance for the present invention; they represent the set of parameters defining the characteristics and QoS expectations for the SCS stream (e.g. Minimum and Maximum Service Intervals, Minimum Data Rate, Delay Bound).

In the illustrative sequence of FIG. 2, initiator STA 2 creates an SCS stream with AP 110, using SCS Request frame 221 that contains a QoS Characteristics element 425 (inside the SCS Descriptor 400) of its P2P traffic, in which the Direction subfield 441 is set to Direct link (value 2). At that time, STA 2 is in the active state, while STA 4 which does not communicate is in the doze state. AP 110 responds with SCS Response frame 222.

The recently introduced SCS mechanism introduced for the EHT standard remains a light-weight protocol for a non-AP MLD (or station) to inform the AP MLD (or AP) of its QoS requirements. As already told, the AP MLD may use any link to convey the SCS stream: any of its affiliated AP can trigger communication of the SCS data via the corresponding affiliated STA of a non-AP MLD. For P2P communication, the used Link is specified by LinkID subfield 444.

SCS streams, because they are used especially for low-latency traffics, are privileged candidates for the Restricted Target Wake Time (rTWT). That is why the SCS stream creation (221, 222) may start a more general phase (220) related to setting up rTWT.

rTWT is based on the Target Wake Time (TWT) mechanism originally defined in the IEEE/802.11ah/ax standards to allow devices to determine when and how frequently they will wake up to send or receive data. TWT allows an AP to manage activity in the network, in order to minimize medium contention between STAs, and to reduce the required amount of time that a STA in the power-save mode on a Link needs to be awake. Thanks to this mechanism, a STA of a non-AP STA MLD can doze except during the TWT service period (SP) intervals setup on this link.

802.11be provides TWT with enhanced medium access protection and resource reservation, called restricted target wake time (r-TWT or rTWT), typically in the scope of servicing latency sensitive traffic. An r-TWT agreement is established using the same procedure used to set up a Broadcast TWT agreement (introduced in IEEE Std 802.11ax-2021), except that the TWT setup frames contain a Broadcast TWT element that includes a Restricted TWT Parameter Set field as described herebelow.

A non-AP station establishes membership in broadcast TWT schedules of the AP, while the AP delivers broadcast TWT parameter sets to the non-AP stations. The non-AP station is said to be the TWT scheduled station, while the AP is said to be the TWT scheduling station.

Negotiations to become a member of or terminate membership in an rTWT schedule (more generally a broadcast TWT) are performed with an exchange of frames that carry TWT elements as shown below, having the Negotiation Type subfield set to 3 (Broadcast TWT). In particular, a non-AP STA MLD may request to become a member of a TWT schedule by transmitting a TWT Request frame to its associated AP MLD that contains a TWT element for a given rTWT schedule.

The AP then advertises the scheduled broadcast TWT (or rTWT) using broadcast TWT elements in its management frames, typically in the beacon frames, FILS Discovery frames and broadcast Probe Response frames.

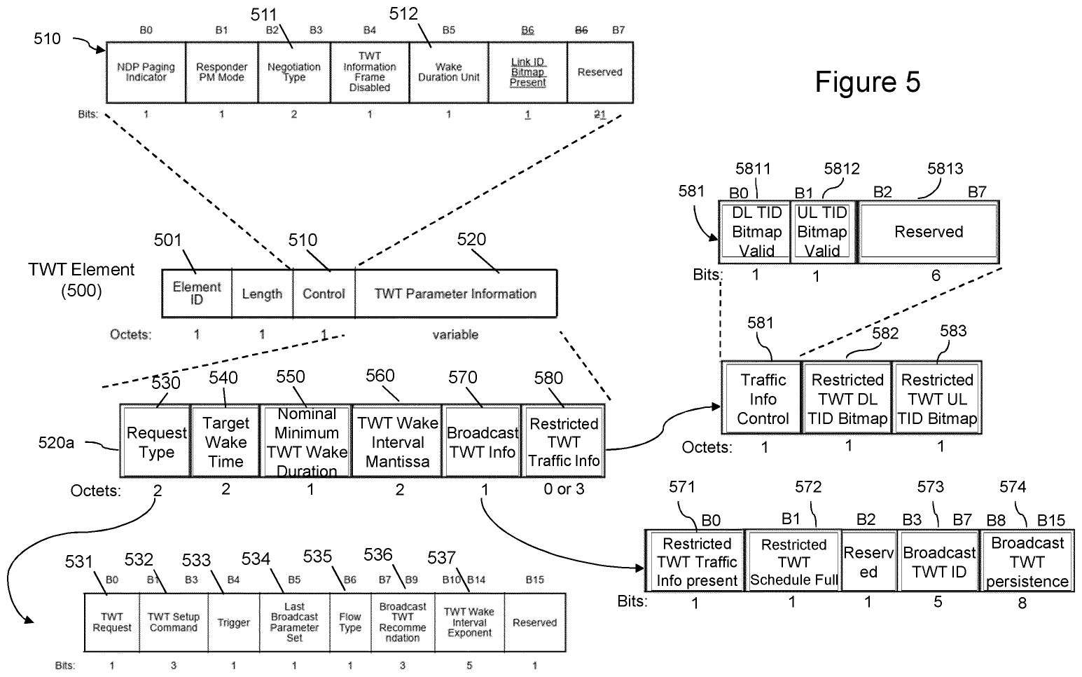

FIG. 5 illustrates a format of a TWT element 500 adapted to be used for r-TWT according to the D1.5 standard.

TWT element 500 is identified by an Element ID 501 and comprises “Control” field 510 and field 520 for transporting TWT parameter information.

“Control” field 510 allows informing through a “Negotiation Type” field 511 whether the TWT is a broadcast TWT or an individual TWT agreement. The MSB of the Negotiation Type subfield 511 is the Broadcast field, therefore the TWT element 500 is referred to as Broadcast TWT element when MSB of subfield 511 is 1. Other fields are of less importance for present description.

“TWT Parameter Information” field 520 contains a single ‘Individual TWT Parameter Set’ field if individual TWT (not shown), and one or more ‘Broadcast TWT Parameter Set’ fields having format 520a shown in the Figure if Broadcast TWT (when Broadcast field of the “Negotiation Type” subfield is 1).

First field in “Broadcast TWT Parameter Set” field 270a is Request Type field 530 comprising:
TWT Request subfield 531 set to 1 when issued by the TWT scheduled STA. Otherwise, set to 0 by the TWT scheduling STA (AP);
TWT Setup Command subfield 532 to indicate the type of TWT command: Request, Suggest, Demand, Reject when issued by a non-AP STA; or Accept, Alternate, Dictate, Reject when issued by a TWT scheduling AP;
Trigger field 533 to indicate whether or not the TWT SP indicated by the TWT element 500 includes triggering frames (the Trigger subfield equals to 1 for r-TWT, for trigger-enabled). Such a TWT SP is named triggered-enabled TWT SP, and no non-AP station cannot start transmitting data within it without previous triggering by the AP;
Broadcast TWT Recommendation field 536 set to 4 to indicate the TWT described in Broadcast TWT element 500 is a restricted TWT (r-TWT). In that case, Broadcast TWT element 500 is also referred to as a restricted TWT element (r-TWT IE), while Broadcast TWT Parameter Set 520a is referred to as Restricted TWT Parameter Set.
Other subfields are of less importance:
   Last Broadcast Parameter Set subfield 534 is set to 0 to indicate that another Broadcast TWT Parameter set follows this set. The Last Broadcast Parameter Set subfield is set to 1 to indicate that this is the last broadcast TWT Parameter set in the broadcast TWT element.
   Flow Type subfield 535 indicates whether the TWT is announced (the TWT scheduling AP will wait to receive a frame from TWT scheduled STA to signal its awake state) or not (Flow Type subfield equals to 0 for r-TWT, for “announced” mode, because r-TWT is a trigger-enabled TWT).

Other fields in Restricted TWT Parameter Set field 520a are used to define time Parameters for the rTWT schedule, as follows:
Target Wake Time (TWT) field 540 indicates the next time (in microseconds) at which the station participating in the rTWT schedule should wake up for the next rTWT SP;
Nominal Minimum TWT Wake Duration field 550 indicates the minimum amount of time that the TWT scheduled STA is expected to be awake since the starting time of the TWT SP in order to complete the frame exchanges for the period of TWT Wake Interval. The TWT Wake Interval of the rTWT SP is the value calculated from the TWT Wake Interval Mantissa 560 and TWT Wake Interval Exponent 537. It is expressed in number of units as defined in Wake Duration Unit subfield 512 of Control field 510, e.g. typically 256 μs.

Other fields in Restricted TWT Parameter Set field 520a are used to define parameters specific to the Broadcast and Restricted nature of the rTWT SP:
Broadcast TWT Info field 570.
   It conveys the identifier of the rTWT schedule, namely the Broadcast TWT ID 573 (bTWT ID), that is used to identify the rTWT SPs belonging to the same rTWT schedule. This identifier, which is not 0, hence allows an AP to schedule multiple sets of Broadcast TWT SPs with different sets of TWT parameters;
   It specifies, through Broadcast TWT Persistence subfield 574, the number of Target Beacon Transmission Times (TBTT) during which the Broadcast TWT SPs corresponding to this Restricted (more generally Broadcast) TWT Parameter set are present;
   It also signals, through Restricted TWT Schedule Full subfield 572, when set to 1, that the r-TWT scheduling AP is unlikely to accept a request from a STA in the BSS to establish a new membership in the corresponding schedule (identified by bTWT ID 573);
   Finally, it also signals, through Restricted TWT Traffic Info Present field 571, whether Restricted TWT Traffic Info field 580 is present (field 571 to 1) or not.
Restricted TWT Traffic Info field 580 specific to the restriction of the Broadcast TWT to specific traffics. This field is mandatory (hence field 571 is mandatorily set to 1) when the broadcast TWT is related to an SCS LL stream (otherwise, the Traffic Info is related to TIDs).
   It comprises Traffic Info Control field 591 that indicates whether the following fields 582 and 583 are provided (i.e. “valid”). DL TID Bitmap Valid subfield 5811 (respectively UL TID Bitmap Valid subfield 5812) indicates whether the Restricted TWT DL TID Bitmap field 582 (respectively Restricted TWT UL TID Bitmap field 583) has valid information.
   Restricted TWT DL TID Bitmap field 582 (respectively Restricted TWT UL TID Bitmap field 583) identifies TIDs as latency sensitive traffic for DL (respectively UL) directions, i.e. TIDs that are allowed in the rTWT defined by Restricted TWT element 500. The TIDs may be those defining SCS streams. A value of 1 at bit position k in the bitmap indicates that TID k is classified as latency sensitive traffic stream for the concerned transmission direction.

The TWT SP of an rTWT schedule is uniquely identified by the <bTWT ID, MAC address of TWT scheduling AP>tuple.

In the illustrative sequence of FIG. 2, initiator STA 2 requests AP 110 to become an r-TWT scheduled STA, by negotiating r-TWT SPs (TWT Request frame 223) for its low latency traffics, to which the P2P traffic with STA 4 belongs. For example, initiator STA 2 may negotiate the wake TBTT, wake interval and the SCS streams to be allowed in the rTWT. AP 110 provides a TWT Response frame 224 accepting or refusing the request. In other words, STA 2 requests membership in an rTWT schedule.

TWT Request frame 223 carries TWT elements with the Negotiation Type subfield 511 set to 3 and the TWT Setup Command field 532 set to Request TWT, Suggest TWT, or Demand TWT. The Restricted TWT Parameter set 520a indicates the Broadcast TWT ID 573 of the rTWT schedule that the STA is requesting to join. The AP has possibility to answer (TWT Response frame 224) with no new rTWT schedule for the bTWT ID (keep existing one), or offering an alternative set of parameters to those indicated in TWT Request frame 223, or creating a new rTWT schedule with a new bTWT ID.

Once the negotiation and membership completed, rTWT scheduled STA 2 that is in awake state may enter, thanks to the advertising of the rTWT SPs (e.g. through beacon frames 230), the doze state after receiving a Beacon frame with a Restricted TWT element indicating the existence of an rTWT schedule and switch back to the awake state at the rTWT start times. The Beacon frame indicates an rTWT SP during which the TWT scheduling AP intends to send Trigger frames, or DL BUs to the TWT scheduled STAs.

As a result, both STA 2 and STA 4 receive Beacon frame 230, but only STA2 that has negotiated the rTWT schedule (and in member thereof) will decode such periods of activity. Only STA2 will be awake for the rTWT SP 240.

It is often recommended that the TWT scheduling AP receives any indication that the TWT scheduled STA is in the awake state within that rTWT SP (see Flow Type subfield 535), because it may be in the doze mode just before the rTWT SP starts. A specific procedure is implemented based on a trigger frame sent by the TWT scheduling AP. Hence, TWT scheduling AP 110 ensures that a trigger frame 241 (e.g. PS-Poll Trigger frame) is scheduled at the start of the rTWT SP 240, in response to which the TWT scheduled stations (here STA 2) can advertise of its awake state (e.g. PS-Poll frame 242). TWT scheduling AP 110 can block-acknowledge (243) the PS-Poll frames 242 to multiple TWT scheduled stations.

Being aware of the TWT scheduled stations in the awake state, TWT scheduling AP 110 uses OFDMA Multi-User techniques (e.g. MU UL trigger-based transmission, MU DL transmission) to manage the rTWT SP and possibly offer resource units to all or part of the TWT scheduled stations in the awake state.

As example, within such a trigger-enabled rTWT SPs, the Triggered TXOP Sharing (TXS) mechanism may be used, sending a MU RTS TXS trigger frame 244 to allocate a portion of the time within the TXOP (obtained through the trigger frame) to one of the TWT scheduled stations in the awake state, here STA 2, for transmitting data.

An Allocation Duration subfield in the MU-RTS TXS Trigger frame 244 indicates the time duration allocated to STA 2 within the TXOP obtained by TWT scheduling AP 110 with the rTWT SP 240. There is only one User Info field and it is addressed to STA 2 (i.e., AID12 subfield is set to a value between 1 and 2006 that corresponds to STA2 AID in this example). A specific information inside MU-RTS TXS Trigger frame 244 is the TXOP Sharing Mode subfield, which is set to 2 to indicate a possible P2P data to be transmitted. Therefore, the rTWT mechanism allows a P2P transmission to take place within the rTWT SPs, that is triggered using the TXS mechanism.

If in response to transmitted MU-RTS TXS Trigger frame 244, STA 2 transmits one or more non-TB PPDUs within the time allocation signalled in the MU-RTS TXS Trigger frame, the first PPDU of the exchange sent by STA 2 is a CTS frame 245.

During the time allocated by TWT scheduling AP 110, TWT scheduled STA2 can transmit non-TB PPDUs 246 to the AP (not illustrated in the figure) or to another STA (typically STA 4 for P2P traffic) if the TXOP Sharing Mode subfield value is 2.

Unfortunately, as shown by state band 202, STA 4 which is not member of the rTWT schedule negotiated by its partner peer STA has no necessity (by its own knowledge) to be awake during that period. It is therefore in the doze state, and unable to receive P2P data from STA 2.

The P2P data are still transported, with is time consuming, and the session will terminate after a timeout (because no acknowledgment is received back).

In addition, the time used to these missed data is detrimental to other stations participating to rTWT SP 240, because this time resource is rare (low latency streams).

As a result, P2P traffic at the non-AP station continuously requests resource allocation in rTWT schedules that is never profitable to it (a peer is missing) and no longer profitable to other AP operations.

The exemplary scenario of FIG. 2 shows that the SCS, TDLS, rTWT and TXS mechanisms can work in combination. They advantageously allow the latency sensitive streams to be clearly identified (SCS), and full channel (TXS) in dedicated transmission windows (rTWT) to be reserved for them. However, the resulting overall mechanism is still deficient to properly handle P2P (or DiL) latency sensitive streams.

It has been sought to efficiently notify the partner peer non-AP station of the BSS, STA 4 in the scenario, about the rTWT schedule in which the initiator peer non-AP station, STA 2, has established membership with the AP of the BSS. This is of course for the partner peer STA 4 to be awake for the service periods to come in this rTWT schedule, hence to be available for P2P communication with initiator peer STA 2.

Embodiments of the invention are based on using the Action frames specific to the TDLS mechanism to provide such notification. In other words, a TDLS Action frame is sent to partner peer STA 4, which frame includes rTWT information about the rTWT schedule in which initiator peer STA 2 has membership. By comprising the Broadcast TWT identifier, bTWT ID, identifying the rTWT schedule, hence its service periods, SPs, the rTWT information allows partner peer STA 4 to obtain the rTWT timing parameters and the like about the SPs, from the Management frames (e.g. Beacon frames 230) sent by the AP. Partner peer STA 4 can therefore awake at this appropriate time to receive (or exchange) P2P data 246 with initiator STA 2 within the rTWT SP 240.

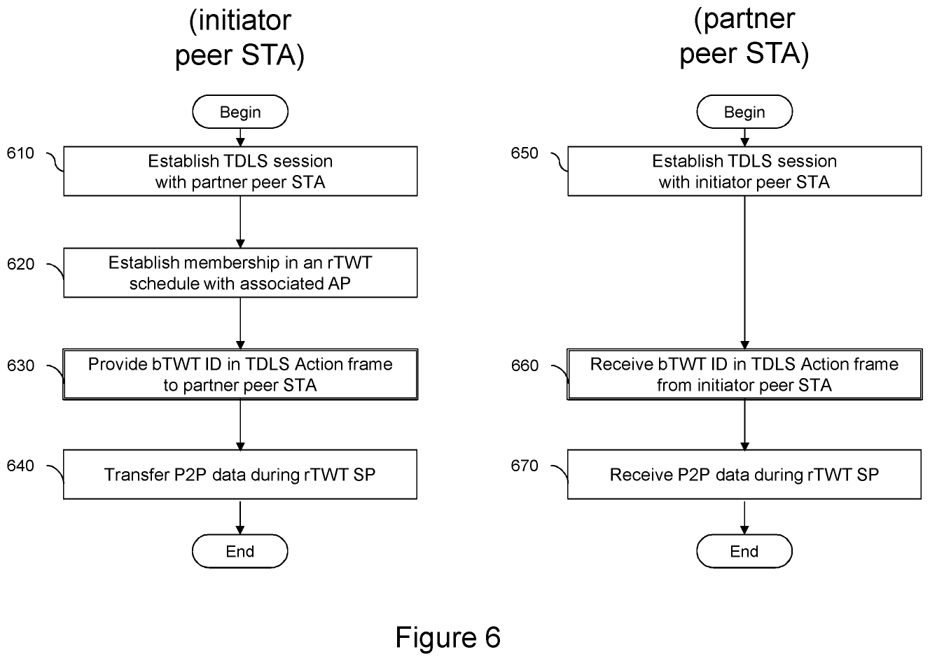

FIG. 6 illustrates, using flowcharts, exemplary steps at the peer non-AP MLDs (or stations) according to some embodiments of the invention.

The peer MLDs are assumed to be associated with the AP MLD, hence belonging to the same BSS, before the process starts. The left part of the Figure represents steps at the initiator peer non-AP station, while the right part represents steps at the partner peer non-AP station.

For the sake of illustration, the STA 2 may take the role of initiator peer STA, or in other words, the role of TDLS initiator STA. The STA 4 may take the role of partner peer STA, or in other words, the role of TDLS responder STA.

In embodiments (as described here below), the TDLS initiator STA acts also as the TWT scheduled STA with the TWT scheduling AP. Alternatively, the TDLS responder STA may act as a scheduled STA to negotiate an rTWT schedule with the TWT scheduling AP.

At step 610, a P2P session is established between the two peer stations, at the initiative of either peer station. This step corresponds to phase 210 of FIG. 2 described above. Correspondingly, the other peer station also establishes the P2P session at step 650.

Next, at step 620, an rTWT agreement is established, including requesting membership in an rTWT schedule and negotiating corresponding Restricted TWT Parameter Set. This step corresponds to phase 220 of FIG. 2 described above. This results in having initiator STA 2 obtaining an rTWT (broadcast TWT) schedule identified by a bTWT ID.

Next, at step 630, initiator peer station, STA 2, transfers at least the bTWT ID to its partner peer station, i.e. to TDLS responder station STA 4, using a TDLS Action frame related to the established TDLS session (i.e. conveying the TDLS identifier—“Link Identifier”—identifying the TDLS session).

In some embodiments, the TDLS Action frame includes an Action frame of the TDLS category (meaning TLDS Action frame) with a TDLS Action field of TDLS Peer Traffic Indication. This corresponds to the existing format of TDLS Action field 302 set to 4 as shown in Table 9-496 of FIG. 3.

In a variant, the TDLS Action frame includes an Action frame of the TDLS category (meaning TLDS Action frame) with a TDLS Action field of TDLS Peer PSM Request/Response. This corresponds to the existing format of TDLS Action field 302 set to 7 and 8 respectively as shown in Table 9-496 of FIG. 3. This variant requires that the TDLS session be already established.

TDLS peer power save mode (TDLS peer PSM) is a power save mechanism that can be used between TDLS peer STAs, and which is based on a periodic wakeup schedule. The station that intends to enter TDLS peer PSM (TDLS peer PSM initiator) sends a TDLS Peer PSM Request frame to the TDLS peer STA (TDLS peer PSM responder), including a proposed periodic wakeup schedule. When the TDLS peer PSM responder accepts the proposed wakeup schedule, it responds with a TDLS Peer PSM Response frame indicating status code SUCCESS.

In an example, when partner peer STA 4 solicits (i.e. in its TDLS Peer PSM Request) a periodic wakeup schedule with initiator peer STA 2, the latter (STA 2) may include the rTWT information about the rTWT schedule (i.e. Broadcast TWT ID element, bTWT ID) in the response to the solicited schedule (i.e. in its TDLS Peer PSM Response).

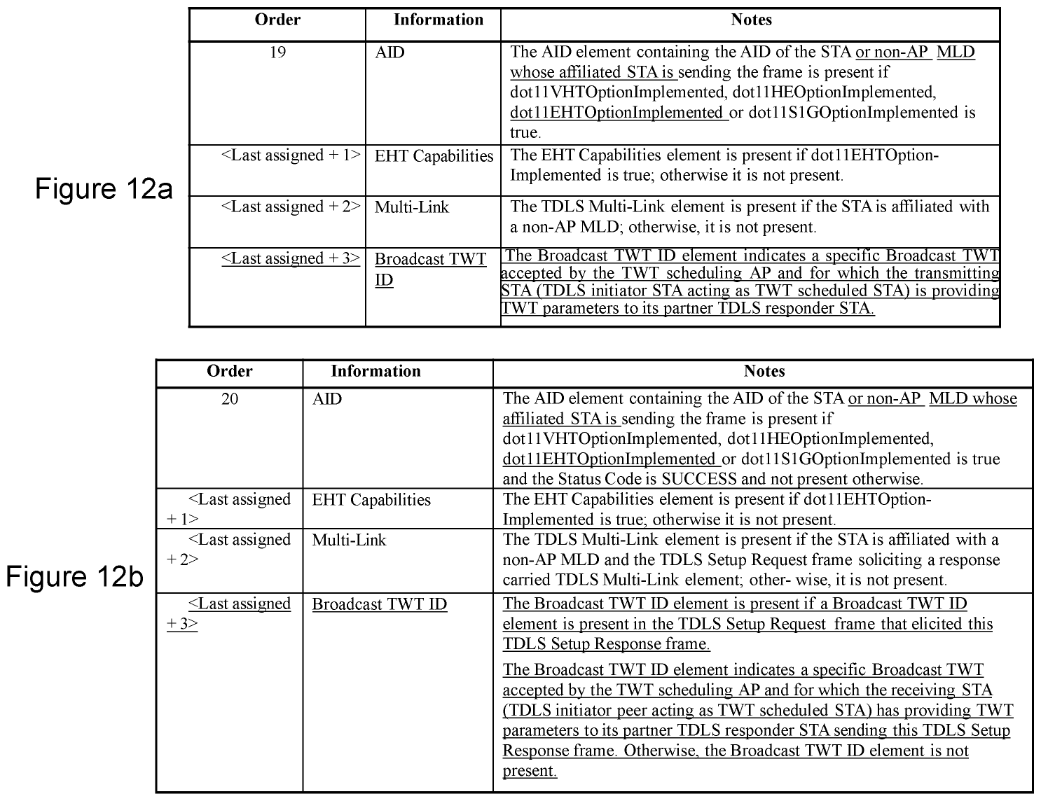

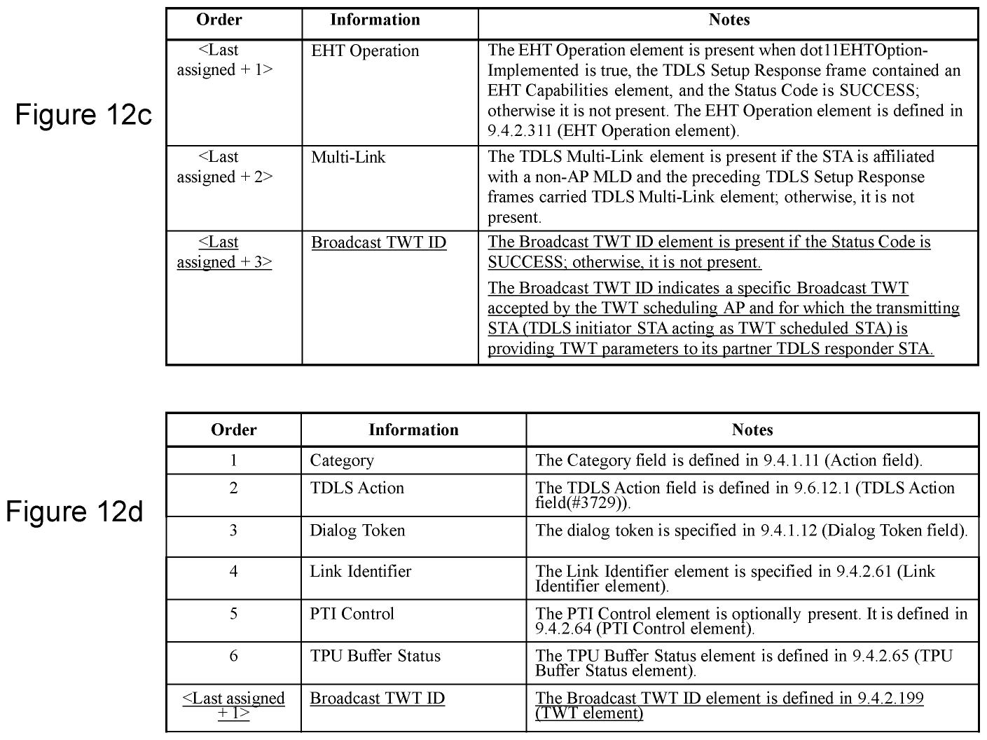

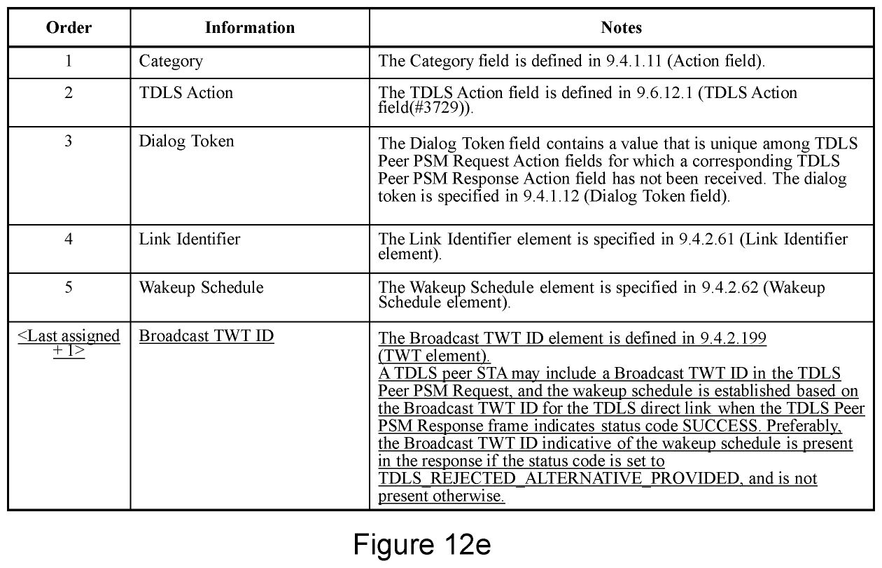

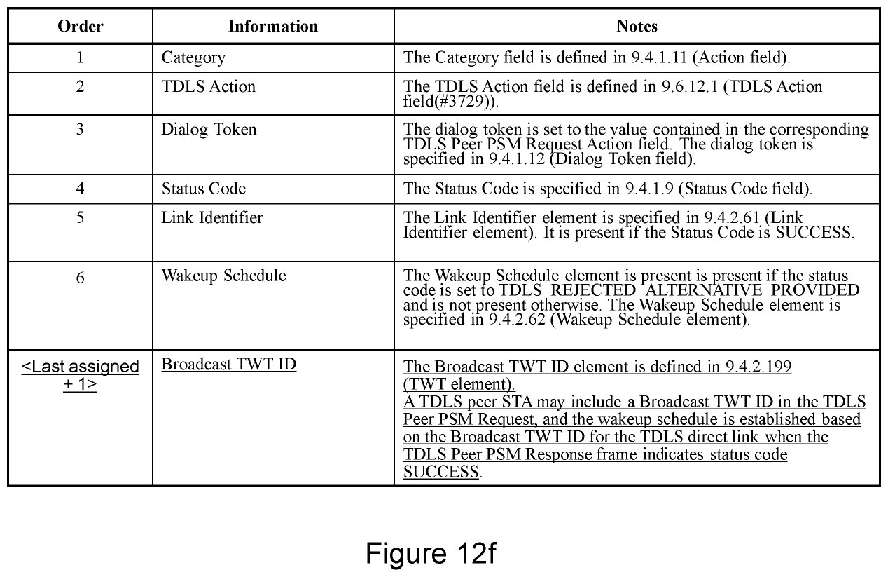

In another example, initiator peer STA 2 may include the rTWT information about the rTWT schedule (i.e. bTWT ID) in the TDLS Peer PSM Request, and the wakeup schedule is established based on the Broadcast TWT ID element (bTWT ID) for the TDLS direct link when the TDLS Peer PSM Response frame indicates status code SUCCESS. Preferably, the rTWT information indicative of the wakeup schedule is present in the response if the status code is set to TDLS_REJECTED_ALTERNATIVE_PROVIDED, and is not present otherwise. FIG. 12e illustrates such addition of Broadcast TWT ID element in the TDLS Peer PSM Request Action frame.

In another example (not represented in the figure), either STA may update an existing wakeup schedule by initiating a TDLS Peer PSM Request/Response exchange, wherein the rTWT information about the rTWT schedule (i.e. bTWT ID) is present in the TDLS Peer PSM request. FIG. 12f illustrates such addition of Broadcast TWT ID element in the TDLS Peer PSM Response Action frame.

In yet another variant, a new type of TDLS Action frame can be defined, in which case the TDLS Action frame includes an Action frame of the TDLS category with a TDLS Action field 302 set to any value from 11 to 255 to define a TDLS Peer rTWT Indication. The function of this newly defined frame, TDLS Peer rTWT Indication, is merely to notify the bTWT ID according to the invention and more generally about an rTWT schedule.

These TDLS Action frames include, in addition to Category field 301 (set to 12) and TDLS Action field 302, Dialog token subfield used for matching action responses with action requests when there are multiple, concurrent action requests and Link identifier (i.e. TDLS session identifier) subfield as parts of the Elements field 303. As shown in FIG. 3, Elements field 303 of the TDLS Peer Traffic Indication frame further comprises optional PTI Control subfield to identify the latest MPDU transmitted to the destination TPU (TDLS Peer U-APSD) sleep STA and TPU Buffer Status subfield indicating the status of the AC buffers at the TPU buffer STA (one bit per each 4 ACs indicates whether the station contains traffic buffered for this category, that is BK, BE, VI and VO).

According to embodiments, Elements field 303 of the TDLS Action frame is supplemented with an additional subfield to carry the notified Broadcast TWT ID element (bTWT ID).

In some embodiments, the rTWT information includes the bTWT ID only, hence reducing overhead while providing simplicity to signal the rTWT SPs. This corresponds to the addition of 5-bit subfield 573 within Elements field 303, as shown by reference 303a in FIG. 3. Various illustrations of modified TDLS Action fields are provided through FIGS. 12a to 12e.

In variants, the rTWT information contains more rTWT information, e.g. includes or is made of a Broadcast TWT Info subfield including the bTWT ID. The partner peer has therefore, as from the notification, knowledge of some timing information concerning the rTWT SPs of the rTWT schedule. This configuration corresponds to the provision, within Elements field 303, of Broadcast TWT Info subfield 570, as shown by reference 303b in FIG. 3.

In other variants, the rTWT information contains even more rTWT information, e.g. includes or is made of a Restricted (Broadcast) TWT Parameter Set subfield including the bTWT ID (and even the Broadcast TWT Info subfield). The partner peer has therefore, as from the notification, knowledge of complete information concerning the rTWT SPs of the rTWT schedule, including negotiated intervals. This configuration corresponds to the provision, within Elements field 303, of Restricted TWT Parameter Set subfield 520a, as shown by reference 303c in FIG. 3. In this variant, part of the Request Type field 530 information, such as TWT Request subfield 531 indicating the type of transmitting STA and TWT Setup Command subfield 532 indicating the type of TWT command, may be of less importance as the element is not transported in a conventional TWT frame. Hence, they can be omitted. Alternatively, the type of TWT command in TWT Setup Command subfield 532 may be declined for other usages, for example to define, depending on its value, varying additional information underlying another subfield. As an illustration:
within a TWT element 520a that includes a TWT Setup Command value 532 of Request TWT, Suggest TWT, Demand TWT, TWT Grouping or Dictate TWT type, the Broadcast TWT ID subfield 573 indicates a specific Broadcast TWT under negotiation for which the transmitting STA (initiator peer) is providing TWT parameters to its partner peer;
within a TWT element 520a that includes a TWT Setup Command value 532 of Accept TWT, the Broadcast TWT ID subfield 573 indicates a specific Broadcast TWT accepted by the AP and for which the transmitting STA (initiator peer) is providing TWT parameters to its partner peer.

Preferably, TWT Request subfield 531 keeps value 1 as the transmitting STA (initiator peer) is not a TWT scheduling STA (it is not the AP).

As mentioned above, the Restricted TWT Parameter Set subfield 520a includes bitmaps 582 and 583 to define, using TIDs, the latency sensitive traffic allowed for DL and UL directions, respectively. Embodiments of the invention contemplate providing an additional bitmap for DiL (i.e. P2P) direction, in order for the partner peer station to be aware of which latency sensitive traffic is allowed during the rTWT.

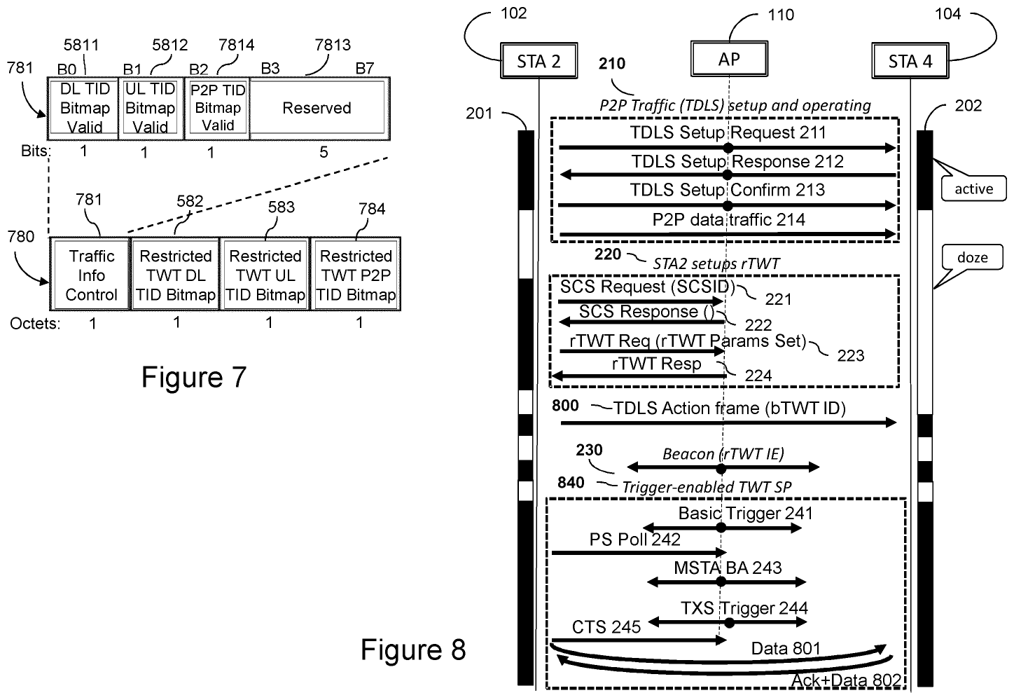

In that respect, the Restricted TWT Parameter Set subfield 303c includes a Restricted TWT P2P TID Bitmap subfield specifying which TID or TIDs are allowed as latency sensitive traffic streams for peer-to-peer exchange within the rTWT schedule (hence SPs), as illustrated in FIG. 7.

This Figure illustrates a format of a modified Restricted TWT Traffic Info subfield 780 within a Restricted TWT Parameter Set subfield 520a according to embodiments of the invention. This subfield 780 is adapted to restrict the TIDs used for P2P traffic within the rTWT SPs of the schedule.

Restricted TWT Traffic Info field 780 is composed of Traffic Info Control field 781 that indicates whether the following fields 582, 583 and 784 are provided (i.e. “valid”).

DL TID Bitmap Valid subfield 5811 and UL TID Bitmap Valid subfield 5812 keep their function to respectively indicate whether the Restricted TWT DL TID Bitmap field 582 and the Restricted TWT UL TID Bitmap field 583 have valid information.

P2P TID Bitmap Valid subfield 7814 indicates whether the Restricted TWT P2P TID Bitmap field 784 has valid information. These fields are preferably used (and set as valid) only when Direction subfield 441 (FIG. 4) of the QoS Characteristic element 425 that describes the traffic flow intended to take benefit from the rTWT schedule, specifies the Direct-link (2) Direction.

Restricted TWT P2P TID Bitmap subfield 784 specifies which TID(s) are identified by the TWT scheduling AP (e.g. under suggestion of the TDLS initiator STA acting as a TWT scheduled STA) as P2P latency sensitive traffic streams.

A value of 1 at bit position k in the bitmap indicates that TID k is classified as latency sensitive traffic stream for P2P. A value of 0 at bit position k in the bitmap indicates that TID k is not classified as P2P latency sensitive traffic stream. Hence, a traffic belonging to a TID having value of 0 at its bit position in the bitmap indicates that it is not allowed to be transmitted over the rTWT SPs of this rTWT schedule. The initiator peer and the partner peer of the TDLS session are supposed to prioritize their transmission of P2P QoS Data frames that are latency sensitive traffic.

Should the TPU Buffer Status subfield be present in the TDLS Action frame (e.g. this is the case for the TDLS Peer Traffic Indication frame) to indicate traffic buffered at the initiator peer at the time the TDLS Action frame is sent, only buffered traffic corresponding to the TID or TIDs specified in the Restricted TWT P2P TID Bitmap subfield 784 may be reported in the TPU Buffer status field. In other words, TPU Buffer Status subfield is in accordance with Restricted TWT P2P TID Bitmap 784. That is to say no AC that contains traffic buffered is reported if none of the corresponding TID is classified as latency sensitive traffic stream for P2P in bitmap 784.

Back to FIG. 6, corresponding to step 630, STA 4 receives the bTWT ID at step 660. Therefore, STA 4 can now identify the rTWT SPs of the rTWT schedule, as advertised in Management frames sent by the AP.

Next, both peer stations conventionally receive the Management frames (e.g. beacon frames 230 in FIG. 2) from the AP and are able to awake at the start of an rTWT SP identified by the bTWT ID. These steps are not shown in the Figure for clarity reasons.

Finally, during a given rTWT SP corresponding to the advertised rTWT schedule, both TDLS peer stations can exchange their P2P data (steps 640 and 670). These steps correspond to phase 240 of FIG. 2 which is slightly modified as explained below with reference to FIG. 8 to correctly transfer P2P data, because both peer stations are now in the awake state for the rTWT SP.

When both peer stations have performed step 620, i.e. they both have established membership in respective rTWT schedule with the AP, only one rTWT schedule may be considered for the P2P transmission. In that case, only one of the two peer stations performs step 630, while the other performs corresponding step 660. Any criterion to determine which rTWT schedule is kept may be implemented, such as for instance the first notification TDLS Action frame (with a bTWT ID) exchanged is kept or the peer station with greater AID value wins.

Also, a peer station may be involved in direct links with multiple other partner peers at the same time. As a consequence, multiple rTWT agreements (memberships in rTWT schedules) may be requested by a TDLS peer STA (or one rTWT schedule may be used for transporting several TDLS sessions).

FIG. 8 illustrates, using frame exchanges in a timeline, the scenario of FIG. 2 when the initiator peer notifies its partner peer of an rTWT schedule for P2P low latency traffic streams according to embodiments of the invention. The same references as in FIG. 2 correspond to the same phases/steps/frames/entities.

As in FIG. 2, prior to establishing membership in the rTWT schedule for P2P purposes, the initiator peer non-AP station, STA 2, negotiates (phase 210) a Tunneled Direct Link Setup, TDLS, session with the partner peer non-AP station, STA 4, as described above (TDLS discovery—not shown—and setup). Of course, in a variant, STA 4 may initiate the TDLS session.

Still as in FIG. 2, initiator peer STA 2 sets up an rTWT schedule with scheduling AP 110 (phase 220) as described above (definition of SCS P2P streams-221-222, negotiation of the rTWT and establishment of membership therein-223-224).

Compared to FIG. 2, once membership in the rTWT schedule has been established, initiator STA 2 notifies partner STA 2 with the rTWT schedule, typically by specifying the corresponding bTWT ID in a TDLS Action frame 800. This TDLS Action frame is sent in an opportunity to transmit within the TDLS session established (hence when both peer stations are simultaneously active as shown by the state bands 201 and 202). It can take any format as specified above with respect to step 630.

The TDLS Action frame 800 is preferably transmitted directly to STA 4, without any relay (forwarding) by the AP. Other transmission paths, including a relay by the AP, may also be contemplated in variants.

The TWT scheduling AP includes a broadcast TWT element in Beacon frame 230 that indicates the rTWT schedule (in which STA 2 has established membership) during which the AP intends to allocate resources to STA 2. Both peer stations receive Beacon frame 230.

As shown in state band 202, partner peer STA 4 now wakes up at the beginning of rTWT SP 840 corresponding to bTWT ID.

In the scenario shown, TWT scheduling AP 110 still sends a PS-Poll Trigger frame 241 to be confirmed that initiator peer STA 2 is awake (PS-Poll frame 242 as a response). TWT scheduling AP 110 can block-acknowledge (243) the PS-Poll frames 242 to multiple TWT scheduled stations.

Next, TWT scheduling AP 110 sends a MU RTS TXS trigger frame 244 to allocate a portion of the time within the TXOP to initiator peer STA 2, which is acknowledged in response by initiator peer STA 2 which sends a CTS frame 245.

Thereafter, as partner peer STA 4 is now present to exchange data with initiator peer STA 2, the latter can directly send its P2P data 801 to partner peer STA 4, which in response performs acknowledgments (and optionally sends data) 802.

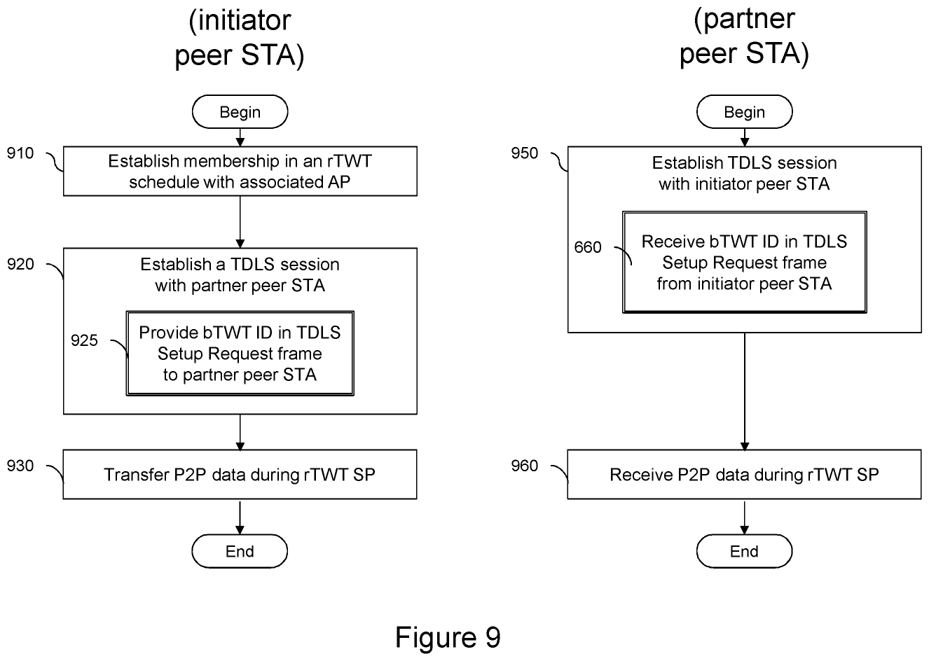

FIG. 9 illustrates, using flowcharts, exemplary steps at the peer non-AP MLDs (or stations) according to alternative embodiments to FIG. 6. In these embodiments, the establishment of membership in an rTWT schedule is made prior to establishing the TDLS session, and the notification of the bTWT ID is made during the TDLS session establishment. In some embodiments, the notifying TDLS Action frame includes a TDLS Setup Request Action frame to establish a Tunneled Direct Link Setup, TDLS, session between the two peer non-AP stations.

Again, the peer non-AP stations are assumed to be associated with the AP.

At step 910, membership in an rTWT schedule is established by initiator peer STA 2 with AP 110. This step corresponds to phase 220 of FIG. 2 and is similar to step 620 described above. This results in having initiator STA 2 obtaining an rTWT (broadcast TWT) schedule identified by a bTWT ID.

Next, at step 920, initiator peer STA 2 starts establishing a TDLS session with partner peer STA 4. Specific to these embodiments, the TDLS Setup Request Action frame includes the negotiated bTWT ID in order to notify STA 4 (substep 925). To that effect, TDLS Setup Request Action frame is supplemented to include any of fields 303a, 303b, 303c described above.

Correspondingly, STA 4 establishes (step 950) a TDLS session with initiator peer STA 2, during which it receives, at step 660, the TDLS Setup Request Action frame carrying the bTWT ID. Therefore, STA 4 can now identify the rTWT SPs advertised in Management frames sent by the AP.

Next, both peer stations conventionally receive the Management frames (e.g. Beacon frames 230 in FIG. 2) from the AP and are able to awake at the start of an rTWT SP identified by bTWT ID. These steps are not shown in the Figure for clarity reasons.

Finally, during a given rTWT SP corresponding to the advertised rTWT, both TDLS peer stations can exchange their P2P data (steps 930 and 960, similar to steps 640 and 670). These steps correspond to phase 840.

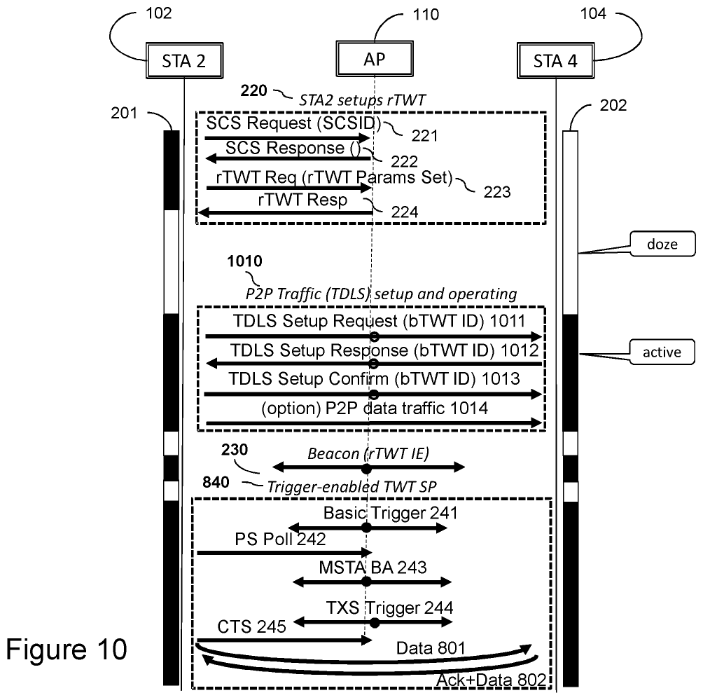

FIG. 10 illustrates, using frame exchanges in a timeline, an alternative scenario to FIG. 8, wherein the establishment of membership in an rTWT schedule is made prior to the establishment of the P2P session.

As in FIGS. 2 and 8, initiator peer STA 2 sets up an rTWT schedule with scheduling AP 110 (phase 220) as described above (definition of SCS P2P streams-221-222, negotiation of the rTWT and establishment of membership therein-223-224).

When initiator peer STA 2 intends to establish (phase 1010) a TDLS session with partner peer STA 4, this initiator peer issues a TDLS Setup Request frame 1011 carrying the negotiated bTWT ID (and more generally any field 303a, 303b or 303c). It is followed by a TDLS Setup Response 1012 from partner peer STA 4, and a TDLS Setup Confirm frame 1013 from initiator peer STA 2.

TDLS Setup Response 1012 may also carry the negotiated bTWT ID (and more generally any field 303a, 303b or 303c).

TDLS Setup Confirm frame 1013 may also carry the negotiated bTWT ID (and more generally any field 303a, 303b or 303c).

If the bTWT IDs provided in TDLS Setup Request frame 1011 and the TDLS Setup Response frame 1012 do not match, initiator peer STA 2 may silently discard the received TDLS Setup Response frame 1012.

In other words, an rTWT schedule may be successfully considered by both initiator and partner peer stations if its bTWT ID is indicated in both TDLS Setup Request frame 1011 and TDLS Setup Response frame 1012, and is confirmed in TDLS Setup Confirm frame 1013.

The TWT scheduling AP includes a broadcast TWT element in Beacon frame 230 that indicates the negotiated rTWT schedule (in which STA 2 has established membership) during which the AP intends to allocate resources to STA2. Both peer stations receive Beacon frame 230.

Similar to FIG. 8 and as shown in state band 202, partner peer STA 4 now wakes up at the beginning of rTWT SP 840 corresponding to bTWT ID.

In the scenario, TWT scheduling AP 110 still sends a PS-Poll Trigger frame 241 to be confirmed that initiator peer STA 2 is awake (PS-Poll frame 242 as a response). TWT scheduling AP 110 can block-acknowledge (243) the PS-Poll frames 242 to multiple TWT scheduled stations.

Next, TWT scheduling AP 110 sends a MU RTS TXS trigger frame 244 to allocate a portion of the time within the TXOP to initiator peer STA 2, which is acknowledged in response by initiator peer STA 2 which sends a CTS frame 245.

Thereafter, as partner peer STA 4 is now present to exchange data with initiator peer STA 2, the latter can directly send its P2P data 801 to partner peer STA 4, which in response performs acknowledgments 802.

The above embodiments (FIGS. 6-10) describe how to efficiently set up an rTWT schedule for P2P transmission between two peer stations having a P2P session. As the AP performs admission control for the TWT and SCS mechanisms, in particular when related to P2P traffic, the AP can also set a policy for the BSS to drive the peer stations to close their P2P (TDLS) sessions in case the AP refuses a TWT or SCS agreement with either of the two peer stations.

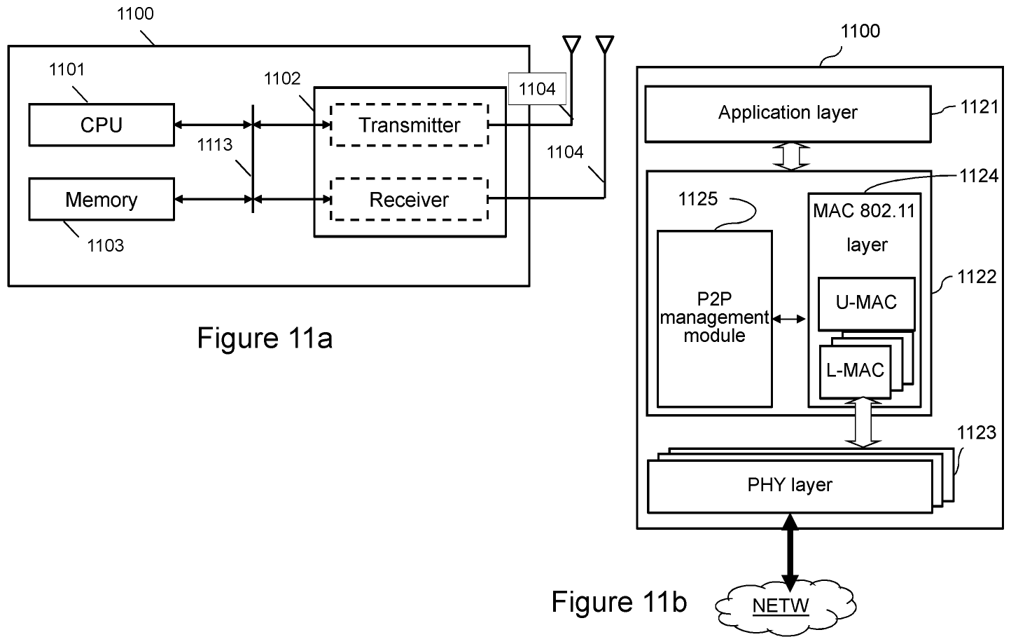

FIG. 11a schematically illustrates a communication device 1100, either a non-AP MLD, embedding a plurality of non-AP stations 110, or an AP MLD, embedding a plurality of APs 100, of a radio network NETW, configured to implement at least one embodiment of the present invention. The communication device 1100 may preferably be a device such as a micro-computer, a workstation or a light portable device. The communication device 1100 comprises a communication bus 1113 to which there are preferably connected:
a central processing unit 1101, such as a processor, denoted CPU;
a memory 1103 for storing an executable code of methods or steps of the methods according to embodiments of the invention as well as the registers adapted to record variables and parameters necessary for implementing the methods; and
at least one communication interface 1102 connected to a wireless communication network, for example a communication network according to one of the IEEE 802.11 family of standards, via transmitting and receiving antennas 1104.

Preferably the communication bus provides communication and interoperability between the various elements included in the communication device 1100 or connected to it. The representation of the bus is not limiting and in particular the central processing unit is operable to communicate instructions to any element of the communication device 1100 directly or by means of another element of the communication device 1100.

The executable code may be stored in a memory that may either be read only, a hard disk or on a removable digital medium such as for example a disk. According to an optional variant, the executable code of the programs can be received by means of the communication network, via the interface 1102, in order to be stored in the memory of the communication device 1100 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 11b is a block diagram schematically illustrating the architecture of the communication device 1100, adapted to carry out, at least partially, the invention. As illustrated, device 1100 comprises a physical (PHY) layer block 1123, a MAC layer block 1122, and an application layer block 1121.

The PHY layer block 1123 (here a multiple of 802.11 standardized PHY layer modules) has the task of formatting, modulating on or demodulating from any 20 MHz channel or the composite channel, and thus sending or receiving frames over the radio medium NETW, such as 802.11 frames, for instance medium access trigger frames to reserve a transmission slot, MAC data and management frames based on a 20 MHz width to interact with legacy 802.11 stations, as well as of MAC data frames of OFDMA type having smaller width than 20 MHz legacy (typically 2 or 5 MHz) to/from that radio medium.

The MAC layer block or controller 1122 preferably comprises a MLE MAC 802.11 layer 1124 implementing conventional 802.11 MAC operations, and additional block 1125 for carrying out, at least partially, embodiments of the invention. The MAC layer block 1122 may optionally be implemented in software, which software is loaded into RAM 1103 and executed by CPU 1101. The MLE MAC 802.11 layer 1124 may implement an Upper-MAC stack along with a series of Lower-MAC modules.

Preferably, the additional block 1125, referred to as P2P management module for performing low-latency service for P2P streams over multi-link communications, implements part of embodiments of the invention (at a peer non-AP MLD). This block performs the operations of FIGS. 6-10 depending on the role of the communication device 1100, initiator or partner peer.

MAC 802.11-layer 1124 and P2P management 1125 interact one with the other in order to establish and process accurately communications over OFDMA RU in between multiple non-AP MLD stations according to embodiments of the invention.

On top of the FIG. 11b, application layer block 1121 runs an application that generates and receives data packets, for example data packets such as a video stream. Application layer block 1121 represents all the stack layers above MAC layer according to ISO standardization.

FIG. 12a illustrates modifications of Table 9-494 (as per 802.11be draft version 3.0) describing the TDLS Setup Request Action field format according to embodiments of the invention.

A new entry is provided (at row numbered last assigned +3) to support a Broadcast TWT ID field. The Broadcast TWT ID element indicates a specific Broadcast TWT accepted by the TWT scheduling AP and for which the transmitting STA (TDLS initiator STA acting as TWT scheduled STA) is providing TWT parameters to its partner TDLS responder STA.

FIG. 12b illustrates modifications of Table 9-495 (as per 802.11be draft version 3.0) describing the TDLS Setup Response Action field format according to embodiments of the invention.

A new entry is provided (at row numbered last assigned +3) to support a Broadcast TWT ID field. The Broadcast TWT ID element is present if a Broadcast TWT ID element is present in the TDLS Setup Request frame that elicited this TDLS Setup Response frame.

The Broadcast TWT ID element indicates a specific Broadcast TWT accepted by the TWT scheduling AP and for which the receiving STA (TDLS initiator peer acting as TWT scheduled STA) has providing TWT parameters to its partner TDLS responder STA sending this TDLS Setup Response frame. Otherwise, the Broadcast TWT ID element is not present.

FIG. 12c illustrates modifications of Table 9-496 (as 802.11be draft version 3.0) describing the TDLS Setup Confirm Action field format according to embodiments of the invention.

A new entry is provided (at row numbered last assigned +3) to support a Broadcast TWT ID field. The Broadcast TWT ID indicates a specific Broadcast TWT accepted by the TWT scheduling AP and for which the transmitting STA (TDLS initiator STA acting as TWT scheduled STA) is providing TWT parameters to its partner TDLS responder STA.

FIG. 12d illustrates modifications of Table 9-501 (as 802.11be draft version 3.0) describing the TDLS Peer Traffic Indication Action field format according to embodiments of the invention.

A new entry is provided (at row numbered last assigned +1) to support a Broadcast TWT ID field. The Broadcast TWT ID element is defined in 9.4.2.199 (TWT element), in IEEE P802.11-REVme™/D1.0, December 2021. The Broadcast TWT ID element, if present, indicates a specific Broadcast TWT in which the transmitting STA is requesting the recipient STA to participate.

By comprising the Broadcast TWT ID identifying the rTWT schedule, hence its service periods, SPs, the TDLS Peer Traffic Indication Action frame allows the receiving TDLS peer STA to obtain the rTWT timing parameters and the like about the SPs, from the Management frames sent by the TWT scheduling AP. The receiving TDLS peer STA can therefore awake at the appropriate time to receive (or exchange) data with TWT scheduled STA (TDLS peer STA) within the rTWT SP.

FIG. 12e illustrates modifications of Table 9-505 (as 802.11be draft version 3.0) describing the TDLS Peer PSM Request Action field format according to embodiments of the invention.

A new entry is provided (at row numbered last assigned +1) to support a Broadcast TWT ID field. The Broadcast TWT ID element is defined in 9.4.2.199 (TWT element), in IEEE P802.11-REVme™/D1.0, December 2021.

A TDLS peer STA may include a Broadcast TWT ID in the TDLS Peer PSM Request, and the wakeup schedule is established based on the Broadcast TWT ID for the TDLS direct link when the TDLS Peer PSM Response frame indicates status code SUCCESS. Preferably, the Broadcast TWT ID indicative of the wakeup schedule is present in the response if the status code is set to TDLS_REJECTED_ALTERNATIVE_PROVIDED, and is not present otherwise.

FIG. 12f illustrates modifications of Table 9-506 (as 802.11be draft version 3.0) describing the TDLS Peer PSM Response Action field format according to embodiments of the invention.

A new entry is provided (at row numbered last assigned +1) to support a Broadcast TWT ID field. The Broadcast TWT ID element is defined in 9.4.2.199 (TWT element), in IEEE P802.11-REVme™M/D1.0, December 2021.

A TDLS peer STA may include a Broadcast TWT ID in the TDLS Peer PSM Request, and the wakeup schedule is established based on the Broadcast TWT ID for the TDLS direct link when the TDLS Peer PSM Response frame indicates status code SUCCESS.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular, the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A peer-to-peer communication method in a wireless network, comprising at an initiator peer non-access point, AP, station of a BSS:
establishing a broadcast Target Wake Time, bTWT, schedule with an AP of the BSS,
notifying a partner peer non-AP station of the BSS about the bTWT schedule, wherein notifying includes sending, to the partner peer non-AP station, a TDLS Action frame including bTWT information about the bTWT schedule, and
exchanging, during one or more bTWT service periods, SPs, of the bTWT schedule, peer-to-peer data directly with the partner peer non-AP station.

2. A peer-to-peer communication method in a wireless network, comprising at a partner peer non-access point, AP, station of a BSS managed by an AP:
receiving a notification from an initiator peer non-AP station of the BSS about a broadcast Target Wake Time, bTWT, schedule in which the initiator peer non-AP station has established membership with the AP of the BSS, wherein the notification includes a TDLS Action frame including bTWT information about the bTWT schedule, and
exchanging, during one or more bTWT service periods, SPs, of the bTWT schedule, peer-to-peer data directly with the initiator peer non-AP station.

3. The method of claim 1, wherein the bTWT information includes a Broadcast TWT identifier, bTWT ID, identifying the bTWT schedule.

4. The method of claim 3, wherein the bTWT information is made of the bTWT ID only.

5. The method of claim 1, wherein the bTWT information includes or is made of a Broadcast TWT Info subfield including the bTWT ID.

6. The method of claim 1, wherein the bTWT information includes or is made of a Restricted TWT Parameter Set subfield including the bTWT ID.

7. The method of claim 6, wherein the Restricted TWT Parameter Set subfield includes a Restricted TWT P2P TID Bitmap subfield specifying which Traffic Identifier, TID, or TIDs are allowed as latency sensitive traffic streams for peer-to-peer exchange within the bTWT schedule.

8. The method of claim 7, wherein the TDLS Action frame includes both the Restricted TWT Parameter Set subfield and a TPU Buffer Status field containing information regarding traffic buffered at the initiator peer non-AP station at the time the TDLS Action frame is sent, wherein only buffered traffic corresponding to the TID or TIDs specified in the Restricted TWT P2P TID Bitmap subfield is reported in the TPU Buffer status field.

9. The method of claim 1, wherein the TDLS Action frame includes an Action frame of the TDLS category with a TDLS Action field of TDLS Peer Traffic Indication or TDLS Peer Power Save Mode Request or Response.

10. The method of claim 1, wherein the TDLS Action frame includes an Action frame of the TDLS category with a TDLS Action field set to any value from 11 to 255 to define a TDLS Peer bTWT Indication.

11. The method of claim 1, wherein the TDLS Action frame includes a TDLS Setup Request Action frame to establish a Tunneled Direct Link Setup, TDLS, session between the two peer non-AP stations.

12. The method of claim 11, further comprising exchanging a TDLS Setup Response Action frame and a TDLS Setup Confirm Action frame between the two peer non-AP stations, wherein the TDLS Setup Response and Confirm Action frames include the bTWT information.

13. The method of claim 1, further comprising, at the initiator peer non-AP station, prior to establishing membership in the bTWT schedule, negotiating a Tunneled Direct Link Setup, TDLS, session with the partner peer non-AP station, wherein the TDLS Action frame is sent within the TDLS session.

14. The method of claim 2, further comprising, at the partner peer non-AP station, negotiating a Tunneled Direct Link Setup, TDLS, session with the initiator peer non-AP station, wherein the TDLS Action frame is received within the TDLS session once established.

15. The method of claim 1, wherein the initiator peer non-AP station or the partner peer non-AP station is affiliated to a non-AP multi-link device, MLD.

16. A wireless communication device comprising at least one microprocessor configured for carrying out the steps of a peer-to-peer communication method in a wireless network:
establishing a broadcast Target Wake Time, bTWT, schedule with an AP of a BSS,
notifying a partner peer non-AP station of the BSS about the bTWT schedule, wherein notifying includes sending, to the partner peer non-AP station, a TDLS Action frame including bTWT information about the bTWT schedule, and
exchanging, during one or more bTWT service periods, SPs, of the bTWT schedule, peer-to-peer data directly with the partner peer non-AP station.

17. A non-transitory computer-readable medium storing a program which, when executed by a microprocessor or computer system in a wireless device, causes the wireless device to perform the method of claim 1.

18. A wireless communication device comprising at least one microprocessor configured for carrying out the steps of a peer-to-peer communication method in a wireless network:
receiving a notification from an initiator peer non-AP station of a BSS managed by an AP, about a broadcast Target Wake Time, bTWT, schedule in which the initiator peer non-AP station has established membership with the AP of the BSS, wherein the notification includes a TDLS Action frame including bTWT information about the bTWT schedule, and
exchanging, during one or more bTWT service periods, SPs, of the bTWT schedule, peer-to-peer data directly with the initiator peer non-AP station.
